(19) United States
(12) Patent Application Publication
(10) Pub. No.: US 2025/0071667 A1
(43) Pub. Date: Feb. 27, 2025

(54) METHOD AND APPARATUS FOR SLICE MANAGEMENT IN WIRELESS COMMUNICATION SYSTEM

(71) Applicant: SAMSUNG ELECTRONICS CO., LTD., Suwon-si (KR)

(72) Inventors: Mahmoud WATFA, Staines (GB); Lalith KUMAR, Bangalore (IN)

(21) Appl. No.: 18/811,538

(22) Filed: Aug. 21, 2024

(30) Foreign Application Priority Data
Aug. 21, 2023 (IN) 202331055916
Aug. 23, 2023 (IN) 202331056517
Jul. 19, 2024 (GB) 2410569.4

(51) Int. Cl. H04W 48/16; H04W 72/21

(52) U.S. Cl. CPC H04W 48/16; H04W 72/21

(57) ABSTRACT

The disclosure relates to a 5G or 6G communication system for supporting a higher data transmission rate. A method performed by a user equipment (UE) in a wireless communication system is provided. The method comprises receiving, from a base station, a protocol data unit (PDU) session modification command message for a modification of a PDU session, in case that the PDU session modification command message includes an alternative single-network slice selection assistance information (S-NSSAI), setting an S-NSSAI for a PDU session establishment procedure to an S-NSSAI of the PDU session and transmitting, to the base station, a message for requesting a PDU session establishment for the PDU session establishment procedure, wherein the message includes the S-NSSAI of the PDU session.

### CROSS-REFERENCE TO RELATED APPLICATIONS

This application is based on and claims priority under 35 U.S.C. § 119 to Indian Patent Application number 202331055916 filed on Aug. 21, 2023, and Indian Patent Application number 202331056517 filed on Aug. 23, 2023, in the Indian Intellectual Property Office, and United Kingdom Patent Application No. 2410569.4 filed on Jul. 19, 2024, in the United Kingdom Intellectual Property Office, the disclosure of which are incorporated by reference herein in their entirety.

### BACKGROUND

### 1. Field

The present disclosure relates to the management of network slices in a telecommunication network. It particularly relates to a scenario where a slice requires replacement. Embodiments find particular, but not exclusive, use in a fifth generation (5G) system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

A method performed by a user equipment (UE) in a wireless communication system is provided. The method comprises receiving, from a base station, a protocol data unit (PDU) session modification command message for a modification of a PDU session, in case that the PDU session modification command message includes an alternative single-network slice selection assistance information (S-NSSAI), setting an S-NSSAI for a PDU session establishment procedure to an S-NSSAI of the PDU session and transmitting, to the base station, a message for requesting a PDU session establishment for the PDU session establishment procedure, wherein the message includes the S-NSSAI of the PDU session.

A user equipment (UE) in a wireless communication system is provided. The UE comprises a transceiver and a controller coupled with the transceiver and configured to receive, from a base station, a protocol data unit (PDU) session modification command message for a modification of a PDU session, in case that the PDU session modification command message includes an alternative single-network slice selection assistance information (S-NSSAI), set an S-NSSAI for a PDU session establishment procedure to an S-NSSAI of the PDU session, and transmit, to the base station, a message for requesting a PDU session establishment for the PDU session establishment procedure, wherein the message includes the S-NSSAI of the PDU session.

A method performed by a base station in a wireless communication system is provided. The method comprises transmitting, to a user equipment (UE), a protocol data unit (PDU) session modification command message for a modification of a PDU session and receiving, from the UE, a message for requesting a PDU session establishment for a PDU session establishment procedure, wherein, in case that the PDU session modification command message includes an alternative single-network slice selection assistance information (S-NSSAI), an S-NSSAI for the PDU session establishment procedure is based on an S-NSSAI of the PDU session, and wherein the message includes the S-NSSAI of the PDU session.

A base station in a wireless communication system is provided. The base station comprises a transceiver and a controller coupled with the transceiver and configured to transmit, to a user equipment (UE), a protocol data unit (PDU) session modification command message for a modification of a PDU session, and receive, from the UE, a message for requesting a PDU session establishment for a PDU session establishment procedure, wherein, in case that the PDU session modification command message includes an alternative single-network slice selection assistance information (S-NSSAI), an S-NSSAI for the PDU session establishment procedure is based on an S-NSSAI of the PDU session, and wherein the message includes the S-NSSAI of the PDU session.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a single-network slice selection assistance information (S-NSSAI) information element according to various embodiments of the present disclosure;

FIG. 2A illustrates an alternative NSSAI information element and an entry according to various embodiments of the present disclosure;

FIG. 2B illustrates an alternative NSSAI information element and an entry according to various embodiments of the present disclosure;

FIG. 3 illustrates a flowchart of method according to various embodiments of the present disclosure;

FIG. 4 illustrates a structure of a UE according to various embodiments of the present disclosure; and

FIG. 5 illustrates a structure of a base station according to various embodiments of the present disclosure.

### DETAILED DESCRIPTION

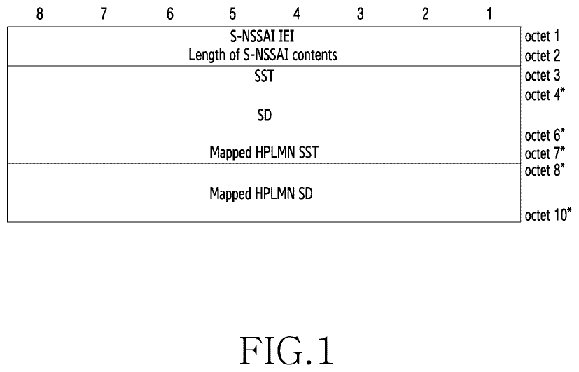

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIGS. 1-5, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The 5G system (5GS) supports network slice replacement and network slice instance replacement as described in sections 5.15.19 and 5.15.20, respectively, of 3GPP TS 23.501 V18.2.1, both of which are reproduced below:

### 5.15.19 Support of Network Slice Replacement

The network slice replacement feature is used to replace a single-network slice selection assistance information (S-NSSAI) with an alternative S-NSSAI when an S-NSSAI becomes unavailable or congested. The network slice replacement may be triggered in the following cases:
If the network slice selection function (NSSF) detects that an S-NSSAI becomes unavailable or congested (e.g., based on OAM or NWDAF analytics output), the NSSF sends network slice availability notification for the S-NSSAI to the AMF. The notification may include an alternative S-NSSAI which can be used by the AMF to replace the S-NSSAI. The NSSF notifies the AMF when the S-NSSAI is available again.
If the policy control function (PCF) detects that an S-NSSAI becomes unavailable or congested for a user equipment (UE) (e.g., based on OAM or network data analytics function (NWDAF) analytics output), the PCF sends access and mobility related policy notification to the AMF. The notification may include an alternative S-NSSAI which can be used by the AMF to replace the S-NSSAI. The PCF notifies the AMF when the S-NSSAI is available again for the UE.
The OAM sends notification to AMF when an S-NSSAI becomes unavailable or congested (and also when this S-NSSAI becomes available again) and provides the alternative S-NSSAI to AMF.

Based on the notification above from NSSF or PCF or OAM, the AMF may determine that an S-NSSAI is to be replaced with alternative S-NSSAI. For roaming case, the AMF may receive network slice availability notification of the home public land mobile network (HPLMN)S-NSSAI from NSSF in the HPLMN via NSSF in visited PLMN (VPLMN), to trigger the network slice replacement of the HPLMN S-NSSAI as described in clause 5.15.6.

NOTE 1: It is recommended that, the operator configures to use only one mechanism when triggering the network slice replacement for S-NSSAI.

The AMF determines the alternative S-NSSAI for a UE registered with the S-NSSAI based on the notification from NSSF or PCF, or based on local configuration in case that the NSSF or PCF do not provide an alternative S-NSSAI. The alternative S-NSSAI may be supported in the UE Registration Area. In case that AMF cannot determine the alternative S-NSSAI for the S-NSSAI, e.g., PCF or NSSF does not provide alternative S-NSSAI, the AMF may further interact with the PCF to determine the alternative S-NSSAI. The event trigger in AMF for interacting with PCF is described in clause 6.1.2.5 of TS 23.503 [45].

The UE indicates the support of network slice replacement feature during the UE registration procedure. For supporting UE in connection management (CM)-CONNECTED state and if there is a protocol data unit (PDU) sessions in the UE context associated with the S-NSSAI that needs to be replaced, the AMF provides the alternative S-NSSAI for this S-NSSAI in the allowed NSSAI and in the configured NSSAI, if not included yet, and the mapping between S-NSSAI(s) to alternative S-NSSAI(s) to the UE in UE configuration update message as follows:
for non-roaming UEs, the AMF provides the mapping of the S-NSSAI to the alternative S-NSSAI to the UE.
for roaming UEs when the VPLMN S-NSSAI may be replaced by a VPLMN alternative S-NSSAI, the AMF provides the mapping of the VPLMN S-NSSAI to the alternative VPLMN S-NSSAI to the UE.
for roaming UEs when the HPLMN S-NSSAI may be replaced by an alternative HPLMN S-NSSAI, the AMF provides the mapping of the HPLMN S-NSSAI to the alternative HPLMN S-NSSAI to the UE.

NOTE 2: The alternative S-NSSAI or alternative HPLMN S-NSSAI may not be part of the Subscribed S-NSSAI as long as they can be mapped to a HPLMN S-NSSAI that is part of the subscribed S-NSSAIs.

For the supporting UE in CM-IDLE state, when the UE establishes a non access stratum (NAS) signalling connection, e.g., through a service request procedure or through a UE registration procedure, if the AMF determines that the S-NSSAI is to be replaced and there is a PDU session associated with the S-NSSAI in the UE context, the AMF sends the mapping of the S-NSSAI to the alternative S-NSSAI to the UE in the UE configuration update message or in the registration accept message.

NOTE 3: It is left to AMF local policy whether to send the mapping of the S-NSSAI to the alternative S-NSSAI to the UE when there is no PDU session associated with the S-NSSAI or wait and send the mapping of the S-NSSAI to the Alternative S-NSSAI to the UE when the UE establishes a PDU session associated with the S-NSSAI.

During a new PDU session establishment procedure towards an S-NSSAI,
in case that the UE is provided with the mapping of the S-NSSAI to an alternative S-NSSAI, the UE provides both the alternative S-NSSAI and the S-NSSAI in the PDU session establishment message. When the AMF receives the alternative S-NSSAI and the S-NSSAI in the PDU session establishment message, or when the AMF receives only the S-NSSAI in PDU session establishment message the AMF determines that the S-NSSAI is to be replaced with the alternative S-NSSAI, the AMF includes both the alternative S-NSSAI and the S-NSSAI to the session management function (SMF).
in case that the UE is not provided with the mapping of the S-NSSAI to the alternative S-NSSAI, the UE provides the S-NSSAI in the PDU session establishment message. When the AMF determines that the requested S-NSSAI is to be replaced with the alternative S-NSSAI and if the UE supports network slice replacement, the AMF performs UE configuration update procedure to reconfigure the UE with the alternative S-NSSAI. The AMF continues the PDU session establishment procedure with the alternative S-NSSAI and provides both the alternative S-NSSAI and the S-NSSAI to the SMF.

The SMF proceeds with the PDU session establishment using the alternative S-NSSAI. The SMF sends the alternative S-NSSAI to next generation radio access network (NG-RAN) in N2 SM information and to UE in PDU session establishment accept message.

For existing PDU session associated with an S-NSSAI that is replaced with the alternative S-NSSAI, after the AMF sends mapping of the S-NSSAI to the alternative S-NSSAI to the supporting UE in UE configuration update message, the AMF sends updates to the SMF of the PDU session, e.g., triggering Nsmf_PDUSession_UpdateSMContext service operation, that the PDU session is to be transferred to alternative S-NSSAI and includes the Alternative S-NSSAI as follows (see details in clause 4.3.3 of TS 23.502):
In case that the SMF determines that the PDU session needs to be retained (e.g., if the anchor UPF can be reused with the alternative S-NSSAI and session and service continuity (SSC) mode 1), the SMF sends the alternative S-NSSAI to the UPF in the N4 message, to the NG-RAN in N2 message and to the supporting UE in PDU session modification command message.
In case that the SMF determines that the PDU session needs to be re-established, the SMF sends the alternative S-NSSAI to the supporting UE either in PDU session modification command if the PDU session is of SSC mode 3, or in PDU session release if the PDU session is of SSC mode 2 or SSC mode 1, to trigger the re-establishment of the PDU session. The UE includes both, the S-NSSAI and the alternative S-NSSAI in the PDU session establishment message.

When the AMF is notified that the S-NSSAI is available again or the congestion of the S-NSSAI has been mitigated, if the AMF has configured the supporting UE with the alternative S-NSSAI, and the AMF determines for the UE to use the S-NSSAI again, the AMF reconfigures the supporting UE (e.g., by using UE configuration update message) to use the S-NSSAI. If there is an existing PDU session associated with the alternative S-NSSAI, the AMF sends to the SMF the updates of PDU session, e.g., triggering Nsmf_PDUSession_UpdateSMContext service operation, that the PDU session is to be transferred to the S-NSSAI.

During a handover procedure, if an S-NSSAI may be replaced with an alternative S-NSSAI, the handover procedure (including any PDU session associated with the S-NSSAI to be replaced) may continue unaffected by the network slice replacement. Any network slice replacement for the S-NSSAI may not take place during the handover.

### 5.15.20 Support of Network Slice Replacement

The network slice instance replacement is used when a PDU session for a given S-NSSAI is established using a selected network slice instance and the S-NSSAI corresponding to this setwork slice instance is associated with multiple network slice instances. In this case, the network may change the network slice instance for the S-NSSAI if the selected network slice instance is no longer available (e.g., due to overload). The AMF may subscribe with the NSSF for notifications when any of the network slice instances served by the AMF is congested or no longer available. In case of roaming, the NSSF of VPLMN subscribes with the NSSF of the HPLMN for notifications. When the NSSF notifies the AMF that a network slice instance is congested or no longer available, for some of PDU sessions associated with the network slice instance that is no longer available, the AMF may delete old NSI ID corresponding to the network slice instance that is no longer available and the SMF of the PDU session(s) selected by using such old NSI ID is informed by the AMF to release the PDU session(s). Subsequently, the SMF triggers the impacted UE(s) to establish new PDU session(s) associated with the same S-NSSAI as described in clause 5.6.9.2 for PDU session(s) of SSC Mode 2 and SSC Mode 3. The AMF selects a new network slice instance for the given S-NSSAI during PDU session establishment.

From the above, particularly the passage-“The UE includes both, the S-NSSAI and the alternative S-NSSAI in the PDU session establishment message”—it can be seen that when the slice replacement procedure requires the establishment of a new protocol data unit (PDU), session, the UE may provide the single-network slice selection assistance information (S-NSSAI, i.e., the slice identifier) which is associated with the current PDU session as well as the alternative S-NSSAI.

The UE may provide an S-NSSAI during a PDU session establishment procedure e.g., based on its UE route selection policy (URSP) rules. However, the S-NSSAI is an optional parameter which means that the UE may not provide it. For example, the URSP rules may be such that a default rule is used for which there is no S-NSSAI which can be provided. In this case, the UE does not provide an S-NSSAI and it is then up to the network (i.e., the access and mobility management Function, AMF) to select a slice for the PDU session. Although the UE may not select an S-NSSAI, the network (i.e., the session management function (SMF)) provides the selected S-NSSAI in the PDU session establishment accept message. As such, regardless of whether the UE provided an S-NSSAI or not, the UE may know the slice that is being used for the PDU session based on the S-NSSAI parameter that is received in the PDU session establishment accept message.

A slice may be congested and for this the network may provide a back-off (BO) timer to the UE and the UE may not be allowed to request a PDU session for the slice in question. However, the BO timer is not always associated with an S-NSSAI. For example, during a PDU session establishment procedure, the UE may not provide an S-NSSAI as explained above.

The SMF may be congested for a particular slice and so the network may apply congestion control to avoid more load on the slice. If the network-in the case that the UE did not actually provide an S-NSSAI during the PDU session establishment-selects the slice for the UE and the slice happens to be congested, then the BO timer that is provided to the UE is deemed to be associated with “no S-NSSAI.” This means that the UE, while the BO timer is running, is not allowed to request a PDU session such that no S-NSSAI is provided by the UE (except for emergency services). Therefore, the BO timer is associated with “no S-NSSAI.” However, the UE can actually send a request to establish a PDU session for another slice if the S-NSSAI is actually determined and provided by the UE.

The following summary can thus be made regarding the association of a BO timer with slice congestion:
In case that the UE explicitly provided an S-NSSAI during the PDU session establishment procedure and a BO timer is provided to the UE, then the UE considers the BO timer to be associated with the S-NSSAI that is explicitly provided by the UE. The UE is not allowed to send another request for this S-NSSAI until the timer expires or is stopped. However, the UE is allowed to send another request for a different S-NSSAI (including “no S-NSSAI”).
In case that the UE did not provide an S-NSSAI during the PDU session establishment procedure and a BO timer is provided to the UE, then the UE considers the BO timer to be associated with no S-NSSAI. The UE is not allowed to send any 5GSM request that is not associated with any slice (i.e., that is associated with “no S-NSSAI”) until the timer expires or is stopped. The UE can send another request for another slice that may be provided and that may be different from “no S-NSSAI.”

From the above it can be seen that the association of a BO timer with a slice really depends on the information that the UE provided during the PDU establishment procedure.

A first problem experienced in the prior art is a lack of clarity with respect to which S-NSSAI the UE may provide when establishing a new PDU session due to slice replacement.

As indicated above, when the UE established a new PDU session due to slice replacement, the UE is supposed to provide the following parameters:
1. an S-NSSAI which is associated with the current PDU session (that is to be replaced), and
2. the alternative S-NSSAI which is the new S-NSSAI that replaces the existing S-NSSAI (identified by the first bullet point above).

The problem can be explained as follows. For the first parameter, i.e., the S-NSSAI which is associated with the current PDU session, it is unclear how to actually determine the parameter especially because of the possibility that the UE may not have provided the parameter during the PDU session establishment procedure. For this case, how the UE may determine the S-NSSAI is unclear.

A second problem is a lack of AMF behavior when an alternative S-NSSAI is not valid or does not exist.

The UE may not provide an alternative S-NSSAI for which the AMF is expected to retrieve one. However, if the AMF is not able to retrieve an alternative S-NSSAI, then it is not clear how the AMF may behave in this case. The same problem exists if the UE did provide an alternative S-NSSAI which is present in the UE's context, or which is not valid.

According to the present disclosure there is provided an apparatus and method as set forth in the appended claims. Other features of the disclosure will be apparent from the dependent claims, and the description which follows.

According to a first aspect of the present disclosure, there is provided a method of operating a user equipment (UE), in a communication with a telecommunication network, wherein if the UE attempts to establish a protocol data unit (PDU), session due to slice replacement of a slice identified by a single-network slice selection assistance information (S-NSSAI) for an alternative S-NSSAI, the UE indicates to the telecommunication network an S-NSSAI value previously received in a PDU session establishment accept message in connection with an existing PDU session.

In an embodiment, the alternative S-NSSAI is sent to the network in a PDU session establishment request message.

In an embodiment, the PDU session establishment request message is sent by a session management function (SMF).

In an embodiment, if the alternative S-NSSAI cannot be determined or is invalid, then an access and mobility management function (AMF) sends a 5GMM STATUS message or DL NAS TRANSPORT message indicating that the alternative S-NSSAI cannot be determined or is invalid.

According to a second aspect of the present disclosure, there is provided apparatus arranged to perform the method of the first aspect.

In an embodiment, the apparatus comprises at least one UE.

The UE uses the S-NSSAI received in the PDU session establishment accept message as the S-NSSAI that is sent in a subsequent PDU session establishment request message which includes an alternative S-NSSAI.

The SMF may send the alternative S-NSSAI in the PDU session establishment accept message whenever an alternative S-NSSAI is used for the establishment of a PDU session.

The AMF sends a 5GMM STATUS message or downlink (DL) NAS TRANSPORT message (with a 5GSM message which is not forwarded) whenever the alternative S-NSSAI cannot be determined or is determined to be invalid. The AMF may indicate with a new 5GMM cause value that the alternative S-NSSAI is invalid or cannot be determined.

Although a few preferred embodiments of the present disclosure have been shown and described, it will be appreciated by those skilled in the art that various changes and modifications might be made without departing from the scope of the disclosure, as defined in the appended claims.

For a better understanding of the disclosure, and to show how embodiments of the same may be carried into effect, reference will now be made, by way of example only, to the accompanying diagrammatic drawings in which:

FIG. 1 illustrates a S-NSSAI information element according to various embodiments of the present disclosure.

In a first embodiment, the UE determines the S-NSSAI based on what the UE has provided as part of the initial PDU session establishment procedure.

Note that the following relates to the case when the UE wants to establish a new PDU session for an alternative S-NSSAI which is replacing an existing S-NSSAI, and for which the UE may already have an established PDU session. As such the following proposals relate to how to set the S-NSSAI when the UE wants to establish a new PDU session for which the UE may provide an S-NSSAI and an alternative S-NSSAI. As such all the details herein apply for the case when the UE is attempting to establish a new PDU session (e.g., when the UE sends the PDU session establishment request message) and also may send an S-NSSAI along with an alternative S-NSSAI, where the S-NSSAI is assumed to be associated with an existing PDU session for which the S-NSSAI is being replaced (by an alternative S-NSSAI).

In this example, the UE determines the S-NSSAI to be the same as the S-NSSAI that the UE used in the PDU session establishment procedure for the PDU session that is already established (or for which the associated S-NSSAI is to be replaced with an alternative S-NSSAI). It should be noted that this means that the UE may have not provided any S-NSSAI and as such the associated S-NSSAI may be “no S-NSSAI.”

Therefore, for the existing PDU session (for which the network has optionally provided an alternative S-NSSAI), if the UE had provided an S-NSSAI during the PDU session establishment procedure, then the UE may consider that S-NSSAI (which was provided by the UE) as the associated S-NSSAI and hence the UE may provide it again (i.e., as the S-NSSAI) when the UE is establishing a new PDU session with an alternative S-NSSAI.

For example, the UE may consider the S-NSSAI that is received in the PDU session establishment accept message as the S-NSSAI that the UE may provide when the UE establishes a new PDU session (e.g., in relation to slice replacement or for an alternative S-NSSAI). Note that this solution may be used by the UE in all cases i.e., regardless of whether or not the UE provided an S-NSSAI during the PDU session establishment procedure of the current PDU session (for which the associated S-NSSAI is to be replaced). Alternatively, this solution may be used only if the UE did not provide an S-NSSAI for the current PDU session for which an S-NSSAI is being replaced (by an alternative S-NSSAI).

In an alternative solution, the UE may behave as follows, in any combination or order:
In case that the UE did not provide an S-NSSAI during the PDU session establishment procedure, then the UE provides the S-NSSAI which was received in the PDU session establishment accept message;
In case that the UE did not provide an S-NSSAI during the PDU session establishment procedure, then the UE does not provide an S-NSSAI during the establishment of the new PDU session, but the UE may provide the alternative S-NSSAI. The UE may indicate that the S-NSSAI is not being provided using any information element (IE) or bit. The UE may include this indication in the uplink (UL) NAS TRANSPORT message; and
In case that the UE did provide an S-NSSAI during the PDU session establishment procedure, then the UE includes the S-NSSAI which was provided as the S-NSSAI. The UE also includes the alternative S-NSSAI.

In another example, the UE determines the S-NSSAI as follows:
The UE receives the alternative S-NSSAI in the PDU session modification command message, noting that this is a single S-NSSAI value representing the alternative slice that may be used (to replace another slice);
The UE is assumed to have an alternative S-NSSAI information which the UE may have received from the AMF (e.g., in the mobility management message such as registration accept or configuration update command message), where this alternative S-NSSAI is a list of entries (or at least one entry) such that each entry contains an S-NSSAI to be replaced and an associated (or mapped) alternative S-NSSAI (which is a single entry that is supposed to replace the S-NSSAI to be replaced);
The UE may use the (single) alternative S-NSSAI (which is received in the PDU session modification command message-hereafter referred to as the 5GSM message) to find the matching (or corresponding)S-NSSAI (or S-NSSAI to be replaced) from the alternative S-NSSAI information (which is not necessarily a single value). When the UE finds a match between the single alternative S-NSSAI (received in the 5GSM message) and the alternative S-NSSAI entry in the alternative S-NSSAI information, then the UE considers the S-NSSAI (to be replaced) of the corresponding alternative S-NSSAI value (for which there is a match) as the S-NSSAI which is associated with the PDU session, or as the S-NSSAI that the UE may provide when establishing a new PDU session (in addition to the alternative S-NSSAI that the UE may also provide); and
The UE may behave as described above regardless of whether the UE provided an S-NSSAI for the current PDU session, or optionally only if the UE provided an S-NSSAI for the current PDU session.

To further clarify the details above, the alternative S-NSSAI received in the 5GSM message (e.g., PDU session modification command message) as taught is section 9.11.2.8 of 3GPP TS 24.501 is reproduced in FIG. 1.

Here, it can be seen that the contents (starting from octet 3, slice service type (SST)) represent the single alternative S-NSSAI entry.

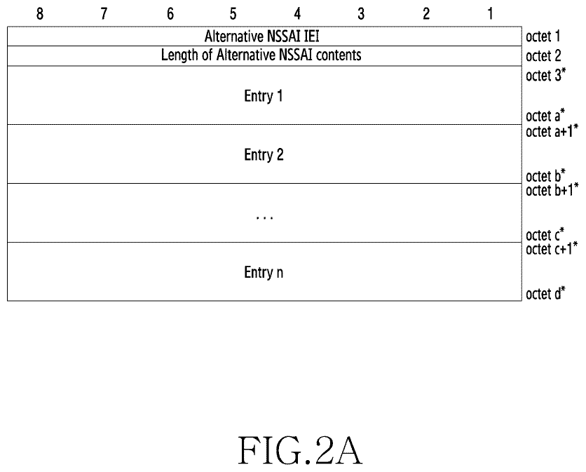

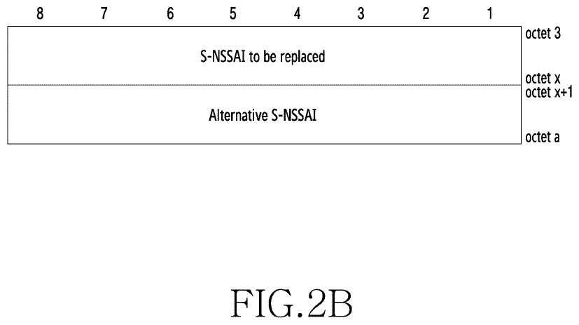

FIG. 2A illustrates an alternative NSSAI information element and an entry and FIG. 2B illustrates an alternative NSSAI information element and an entry according to various embodiments of the present disclosure.

The UE may have alternative S-NSSAI information which is received at the mobility management layer (i.e., from the AMF) which contains at least one entry, and is represented as shown in FIG. 2A and FIG. 2B, which is taken from section 9.11.3.97 of 3GPP TS 24.501.

By reference to FIG. 2, the objective of how to determine the S-NSSAI that may be provided by the UE (in addition to the alternative S-NSSAI) when the UE is establishing a new PDU session (due to slice replacement) will be described. This S-NSSAI is the S-NSSAI to be replaced.

The UE uses the alternative S-NSSAI received in the 5GSM message i.e., represented by FIG. 1 and the UE attempts to find the matching alternative S-NSSAI using the contents shown in FIG. 2A and FIG. 2B, where the alternative S-NSSAI shown in FIG. 2A and FIG. 2B may be checked for a match with the alternative S-NSSAI from FIG. 1 (or where the alternative S-NSSAI shown in FIG. 1 may be checked for a match with the alternative S-NSSAI from FIG. 2A and FIG. 2B). If a match is found, the UE considers the S-NSSAI (i.e., the field referred to as “S-NSSAI to be replaced” in FIG. 2B) to be the S-NSSAI associated with the matching alternative S-NSSAI of FIG. 2B. This S-NSSAI may also be considered as the S-NSSAI to be replaced.

Therefore, after the S-NSSAI is determined (based on the description above), when the UE is establishing a new PDU session (due to slice replacement), the UE provides both the S-NSSAI and the alternative S-NSSAI, where the S-NSSAI is the S-NSSAI which has been determined based on the explanation above (i.e., this is the S-NSSAI to be replaced), and the alternative S-NSSAI is the S-NSSAI which is to replace the S-NSSAI to be replaced. The determined S-NSSAI may be considered to be the S-NSSAI associated with the current PDU session and hence all the proposals herein may apply.

In case that the AMF receives an UL NAS TRANSPORT message which includes an alternative S-NSSAI but does not include an S-NSSAI (in the S-NSSAI IE), then the AMF may behave as follows:
The AMF determines the S-NSSAI to be the S-NSSAI of the PDU session for which a matching alternative S-NSSAI exists. As such, the matching alternative S-NSSAI is used by the AMF to determine the corresponding S-NSSAI which is to be replaced. As such this corresponding S-NSSAI is then determined to be the S-NSSAI;
The AMF may determine to not forward the 5GSM message to an SMF. The AMF may send a DL NAS TRANSPORT message and include the 5GSM message which was not forwarded to an SMF. The AMF may indicate that the 5GSM message was not forwarded because the S-NSSAI is not known (or is missing), or that there is no correspondence or association between the alternative S-NSSAI and the S-NSSAI which is being replaced. The AMF may use a new 5GMM cause value or an existing cause value:
   In case that the UE receives a DL NAS TRANSPORT message with a 5GSM message that is not forwarded, optionally with an indication of a lack of S-NSSAI or lack of association between an S-NSSAI and an alternative S-NSSAI, the 5GMM entity may forward this indication along with the 5G session management (5GSM) message (which was not forwarded) to the 5GSM entity; and
Alternatively, if the AMF receives an alternative S-NSSAI but does not receive an S-NSSAI, the AMF may send the 5GMM STATUS message to the UE and indicate with a new cause value that the S-NSSAI is missing, or that there is no association between an alternative S-NSSAI and an S-NSSAI. The AMF may discard the received 5GSM message. Furthermore, the UE may not request the establishment of a new PDU session for this alternative S-NSSAI optionally until a certain time elapses or until the allowed NSSAI is changed such that this alternative S-NSSAI is part of the allowed NSSAI.

Note that for any of the details herein in which the AMF does not (or cannot) forward a 5GSM message to an SMF, and for any of details herein (or in the current AMF behaviour) for which the AMF does not forward (or cannot forward) a 5GSM message in relation to an alternative S-NSSAI, in case that the AMF sends the DL NAS TRANSPORT message-containing a 5GSM message which was not forwarded to an SMF to a UE, the AMF may include the alternative S-NSSAI in the DL NAS TRANSPORT, optionally the AMF may also include the S-NSSAI which may have been received. The AMF may include the alternative S-NSSAI (optionally together with the S-NSSAI) to indicate any problem which is related to the alternative S-NSSAI. As such for any reason that the AMF is not able to forward a 5GSM message such that the reason is associated with an alternative S-NSSAI (either which is determined by an AMF or explicitly received by an AMF), the AMF may send the alternative S-NSSAI in the DL NAS TRANSPORT so as to notify the UE about the alternative S-NSSAI for which the issue is related to.

Note that the SMF currently only provides on S-NSSAI in the PDU session establishment accept message. This S-NSSAI may be the alternative S-NSSAI in case that the AMF did provide the alternative S-NSSAI to the SMF.

However, as set out herein, the SMF may provide both the S-NSSAI and the alternative S-NSSAI in the PDU session establishment accept message so as to provide the correct information to a UE i.e., so as to clearly and explicitly indicate which S-NSSAI is being replaced and the alternative S-NSSAI that is used to replace the existing S-NSSAI. As such the PDU session establishment accept message now includes both the S-NSSAI and the alternative S-NSSAI whenever the SMF accepts a PDU session that is being established with an alternative S-NSSAI (e.g., for slice replacement feature). When the UE receives a PDU session establishment accept message with both an S-NSSAI and an alternative S-NSSAI, the UE determines that the slice which is replaced is the S-NSSAI in the 5GSM message, and the alternative S-NSSAI is the slice which replaces the S-NSSAI, and that the PDU session is now associated with the indicated alternative S-NSSAI.

A second embodiment relates to AMF behaviour for an invalid (or undetermined) alternative S-NSSAI.

The AMF may receive an UL NAS TRANSPORT message with a 5GSM message such that the AMF may attempt to determine an alternative S-NSSAI. For example, the UL NAS TRANSPORT message may contain an S-NSSAI which the AMF determines to be a slice that may be replaced (e.g., by an alternative S-NSSAI). If the AMF cannot determine the alternative S-NSSAI, then the AMF may not forward the 5GSM message to any SMF. The AMF may then send the DL NAS TRANSPORT message to the UE and include the 5GSM message which was not forwarded. The AMF may indicate that the reason for not forwarding the 5GSM message is because an alternative S-NSSAI is not determined or there is not valid alternative S-NSSAI for the slice which is to be replaced. The AMF may use a new 5GMM cause value or an existing 5GMM cause value in the DL NAS TRANSPORT message.

Note that the AMF may behave as described above if the AMF did receive an alternative S-NSSAI in the UL NAS TRANSPORT message (which contains a 5GSM message) such that the alternative S-NSSAI does not exist or is invalid. In this case, the AMF can also send the DL NAS TRANSPORT message to the UE and optionally include the 5GSM message which was not forwarded. The AMF may indicate the reason is because of an invalid alternative S-NSSAI. The AMF may do so with a new 5GMM cause value. The UE may behave as set out above i.e., the 5GMM entity may send the 5GSM message (which was not forwarded) and the new 5GMM cause value to the 5GSM entity. Furthermore, the UE may not request the establishment of a new PDU session for this alternative S-NSSAI optionally until a certain time elapses or until the allowed NSSAI is changed such that this alternative S-NSSAI is part of the allowed NSSAI.

Note that for any of the details set out herein, the UL/DL NAS TRANSPORT message which carries a 5GSM message may mean that the Payload container type IE is set to “N1 SM information.” It may also mean that the Request type IE is set to “initial request.” Note that any combination of this may also apply. Note that all the details herein may apply in any order or combination.

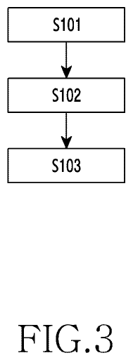

FIG. 3 illustrates, for completeness, a representation of various embodiments of the present disclosure.

Referring to FIG. 3, at S101 a user equipment (UE) is in communication with a telecommunication network. At S102, a slice replacement is required. At S103, the UE indicates to the telecommunication network an S-NSSAI value previously received in a PDU session establishment accept message in connection with an existing PDU session.

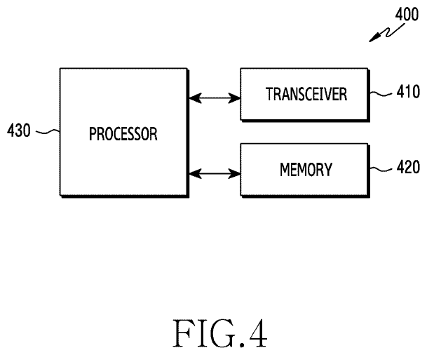

FIG. 4 illustrates a structure of a UE according to various embodiments of the present disclosure.

Referring to FIG. 4, the UE according to an embodiment may include a transceiver 410, a memory 420, and a processor 430. The transceiver 410, the memory 420, and the processor 430 of the UE may operate according to a communication method of the UE described above. However, the components of the UE are not limited thereto. For example, the UE may include more or fewer components than those described above. In addition, the processor 430, the transceiver 410, and the memory 420 may be implemented as a single chip. Also, the processor 430 may include at least one processor. Furthermore, the UE of FIG. 4 corresponds to the UE of FIG. 1 to FIG. 3.

The transceiver 410 collectively refers to a UE receiver and a UE transmitter, and may transmit/receive a signal to/from a base station or a network entity. The signal transmitted or received to or from the base station or a network entity may include control information and data. The transceiver 410 may include a RF transmitter for up-converting and amplifying a frequency of a transmitted signal, and a RF receiver for amplifying low-noise and down-converting a frequency of a received signal. However, this is only an example of the transceiver 410 and components of the transceiver 410 are not limited to the RF transmitter and the RF receiver.

Also, the transceiver 410 may receive and output, to the processor 430, a signal through a wireless channel, and transmit a signal output from the processor 430 through the wireless channel.

The memory 420 may store a program and data required for operations of the UE. Also, the memory 420 may store control information or data included in a signal obtained by the UE. The memory 420 may be a storage medium, such as read-only memory (ROM), random access memory (RAM), a hard disk, a CD-ROM, and a DVD, or a combination of storage media.

The processor 430 may control a series of processes such that the UE operates as described above. For example, the transceiver 410 may receive a data signal including a control signal transmitted by the base station or the network entity, and the processor 430 may determine a result of receiving the control signal and the data signal transmitted by the base station or the network entity.

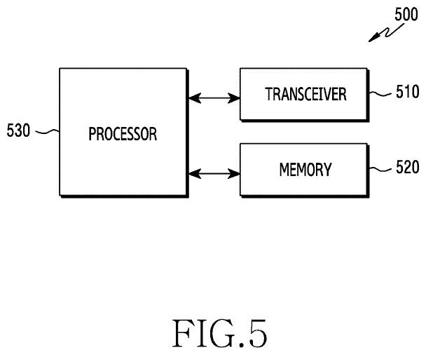

FIG. 5 illustrates a structure of a base station according to various embodiments of the present disclosure.

Referring to FIG. 5, the base station according to an embodiment may include a transceiver 510, a memory 520, and a processor 530. The transceiver 510, the memory 520, and the processor 530 of the base station may operate according to a communication method of the base station described above. However, the components of the base station are not limited thereto. For example, the base station may include more or fewer components than those described above. In addition, the processor 530, the transceiver 510, and the memory 520 may be implemented as a single chip. Also, the processor 530 may include at least one processor. Furthermore, the base station of FIG. 5 corresponds to base station of FIG. 1 to FIG. 4.

The transceiver 510 collectively refers to a base station receiver and a base station transmitter, and may transmit/receive a signal to/from a terminal (UE) or a network entity. The signal transmitted or received to or from the terminal or a network entity may include control information and data. The transceiver 510 may include a RF transmitter for up-converting and amplifying a frequency of a transmitted signal, and a RF receiver for amplifying low-noise and down-converting a frequency of a received signal. However, this is only an example of the transceiver 510 and components of the transceiver 510 are not limited to the RF transmitter and the RF receiver.

Also, the transceiver 510 may receive and output, to the processor 530, a signal through a wireless channel, and transmit a signal output from the processor 530 through the wireless channel.

The memory 520 may store a program and data required for operations of the base station. Also, the memory 520 may store control information or data included in a signal obtained by the base station. The memory 520 may be a storage medium, such as read-only memory (ROM), random access memory (RAM), a hard disk, a CD-ROM, and a DVD, or a combination of storage media.

The processor 530 may control a series of processes such that the base station operates as described above. For example, the transceiver 510 may receive a data signal including a control signal transmitted by the terminal, and the processor 530 may determine a result of receiving the control signal and the data signal transmitted by the terminal.

A method of operating a user equipment (UE) in communication with a telecommunication network is provided. Wherein if the UE attempts to establish a protocol data unit (PDU) session due to slice replacement of a slice identified by a single-network slice selection assistance information (S-NSSAI) for an alternative S-NSSAI, the UE indicates to the telecommunication network an S-NSSAI value previously received in a PDU session establishment accept message in connection with an existing PDU session.

The alternative S-NSSAI is sent to the network in a PDU session establishment request message.

The PDU session establishment request message is sent by a session management function (SMF).

If the alternative S-NSSAI cannot be determined or is invalid, then an access and mobility management function (AMF) sends a 5GMM STATUS message or DL NAS TRANSPORT message indicating that the alternative S-NSSAI cannot be determined or is invalid.

Apparatus arranged to perform the above method.

At least some of the example embodiments described herein may be constructed, partially or wholly, using dedicated special-purpose hardware. Terms such as “component,” “module.” or “unit” used herein may include, but are not limited to, a hardware device, such as circuitry in the form of discrete or integrated components, a field programmable gate array (FPGA) or application specific integrated circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station, a protocol data unit (PDU) session modification command message for a modification of a PDU session;
in case that the PDU session modification command message includes an alternative single-network slice selection assistance information (S-NSSAI), setting an S-NSSAI for a PDU session establishment procedure to an S-NSSAI of the PDU session; and
transmitting, to the base station, a message for requesting a PDU session establishment for the PDU session establishment procedure,
wherein the message includes the S-NSSAI of the PDU session.

2. The method of claim 1, wherein the PDU session establishment procedure is a re-initiated UE-requested PDU session establishment procedure based on the PDU session modification command message.

3. The method of claim 1, wherein the message includes an uplink (UL) non access stratum (NAS) transport message, and
wherein the UL NAS transport message further includes the alternative S-NSSAI.

4. The method of claim 1, wherein the S-NSSAI of the PDU session is included in a PDU session establishment accept message received from the base station before receiving of the PDU session modification command message.

5. The method of claim 1, wherein a session and service continuity (SSC) mode of the PDU session is an SSC mode 3.

6. A user equipment (UE) in a wireless communication system, the UE comprising:
a transceiver; and
a controller coupled with the transceiver and configured to:
receive, from a base station, a protocol data unit (PDU) session modification command message for a modification of a PDU session,
in case that the PDU session modification command message includes an alternative single-network slice selection assistance information (S-NSSAI), set an S-NSSAI for a PDU session establishment procedure to an S-NSSAI of the PDU session, and
transmit, to the base station, a message for requesting a PDU session establishment for the PDU session establishment procedure,
wherein the message includes the S-NSSAI of the PDU session.

7. The UE of claim 6, wherein the PDU session establishment procedure is a re-initiated UE-requested PDU session establishment procedure based on the PDU session modification command message.

8. The UE of claim 6, wherein the message includes an uplink (UL) non access stratum (NAS) transport message, and
wherein the UL NAS transport message further includes the alternative S-NSSAI.

9. The UE of claim 6, wherein the S-NSSAI of the PDU session is included in a PDU session establishment accept message received from the base station before receiving of the PDU session modification command message.

10. The UE of claim 6, wherein a session and service continuity (SSC) mode of the PDU session is an SSC mode 3.

11. A method performed by a base station in a wireless communication system, the method comprising:
transmitting, to a user equipment (UE), a protocol data unit (PDU) session modification command message for a modification of a PDU session; and
receiving, from the UE, a message for requesting a PDU session establishment for a PDU session establishment procedure,
wherein, in case that the PDU session modification command message includes an alternative single-network slice selection assistance information (S-NSSAI), an S-NSSAI for the PDU session establishment procedure is based on an S-NSSAI of the PDU session, and
wherein the message includes the S-NSSAI of the PDU session.

12. The method of claim 11, wherein the PDU session establishment procedure is a re-initiated UE-requested PDU session establishment procedure based on the PDU session modification command message.

13. The method of claim 11, wherein the message includes an uplink (UL) non access stratum (NAS) transport message, and
wherein the UL NAS transport message further includes the alternative S-NSSAI.

14. The method of claim 11, wherein the S-NSSAI of the PDU session is included in a PDU session establishment accept message transmitted to the UE before transmitting of the PDU session modification command message.

15. The method of claim 11, wherein a session and service continuity (SSC) mode of the PDU session is an SSC mode 3.

16. A base station in a wireless communication system, the base station comprising:
a transceiver; and
a controller coupled with the transceiver and configured to:
transmit, to a user equipment (UE), a protocol data unit (PDU) session modification command message for a modification of a PDU session, and
receive, from the UE, a message for requesting a PDU session establishment for a PDU session establishment procedure,
wherein, in case that the PDU session modification command message includes an alternative single-network slice selection assistance information (S-NSSAI), an S-NSSAI for the PDU session establishment procedure is based on an S-NSSAI of the PDU session, and
wherein the message includes the S-NSSAI of the PDU session.

17. The base station of claim 16, wherein the PDU session establishment procedure is a re-initiated UE-requested PDU session establishment procedure based on the PDU session modification command message.

18. The base station of claim 16, wherein the message includes an uplink (UL) non access stratum (NAS) transport message, and
wherein the UL NAS transport message further includes the alternative S-NSSAI.

19. The base station of claim 16, wherein the S-NSSAI of the PDU session is included in a PDU session establishment accept message transmitted to the UE before transmitting of the PDU session modification command message.

20. The base station of claim 16, wherein a session and service continuity (SSC) mode of the PDU session is an SSC mode 3.
